(19) United States
(12) Patent Application Publication
(10) Pub. No.: US 2015/0062311 A1
(43) Pub. Date: Mar. 5, 2015

(54) VIEW WEIGHTING FOR MULTIVIEW DISPLAYS

(71) Applicant: Thomas G. Malzbender, Palo Alto, CA (US)

(72) Inventor: Thomas G. Malzbender, Palo Alto, CA (US)

(73) Assignee: Hewlett-Packard Development Company, L.P., Houston (US)

(21) Appl. No.: 14/389,538

(22) PCT Filed: Apr. 29, 2012
(86) PCT No.: PCT/US2012/035720

§ 371 Date: Sep. 30, 2014

(51) Int. Cl. H04N 13/04

(52) U.S. Cl. CPC H04N 13/0418; H04N 13/0447
USPC 348/51

(57) ABSTRACT

Disclosed is a system and method for presenting multiple horizontally offset views, each view comprised of image data. A computer vision tracker device tracks a left and right eye position for a viewer relative to the display to determine a viewpoint for the left and right eye. A pixel modulation module associates two of the multiple views with the left eye position and the right eye position. Image intensity weighting factors are calculated for the two left eye views and the two right eye views. The intensity of each view associated with the left eye position and right eye position are modulated according to the weighting factors determined for the left eye position and the right eye position. The two left eye views and right eye views are blended into respective single views to be perceived by the left eye and right eye when projected on the display.

### BACKGROUND

Current three-dimensional (3D) displays come in two types, those that require the use of polarized, colored or shuttered glasses and those that do not. The second type of display, typically referred to as ‘autostereoscopic’ or ‘multiview’, has the capability of producing a number of separate images that may be distributed over one angular, horizontal direction. The idea is that since the eyes are horizontally separated, separate images can be made to be viewed by each eye, potentially producing a perception of parallax and thus 3D depth. However, it is extremely difficult to design such a display so that there is no crosstalk between neighboring views. This means that a single eye position will likely receive contributions from more than one angular view being generated. This may lead to visible artifacts.

### SUMMARY

Disclosed in a first embodiment is a system and method for presenting multiple horizontally offset views, each view comprised of image data. A computer vision tracker device tracks a left and right eye position for a viewer relative to the display to determine a viewpoint for the left and right eye. A pixel modulation module associates two of the multiple views with the left eye position and the right eye position. Image intensity weighting factors are calculated for the two left eye views and the two right eye views. The intensity of each view associated with the left eye position and right eye position are modulated according to the weighting factors determined for the left eye position and the right eye position. The two left eye views and right eye views are blended into respective single views to be perceived by the left eye and right eye when projected on the display.

### BRIEF DESCRIPTION OF THE DRAWINGS

FIG. 1 illustrates one embodiment of a multi-view image adjustment system.

FIG. 2 illustrates an example of a display accommodating two viewers according to an embodiment.

FIG. 3 illustrates an image intensity graph plotted against a horizontal position axis according to an embodiment.

FIG. 4 illustrates an embodiment of a logic flow in which an image intensity may be modulated for the specific viewpoint of a viewer.

### DETAILED DESCRIPTION

Multiview displays produce multiple ‘zonal views’, each spanning a certain (typically horizontally) region of viewing space. To achieve continuity between views and avoid dark, blank regions between the views, these zonal views are arranged to overlap somewhat. Although this achieves continuity, the overlap also causes the viewer to see more than one image for most viewing directions. This artifact is often termed ‘bleed through’ between the neighboring views being generated and leads to reduced image quality.

Embodiments describe a method for compensating for such bleed through so that the user sees a single image from any viewing position. For instance, a system implementing embodiments of the method can track a user's eye position in real time and can correctly adjust the multiview images so that the user's perception is of the desired image, not a combination of two such images.

In one example, the exact position of a viewer's eyes may be tracked in real time using computer vision methods. Once a viewer's left and right eye position are known, the expected and modeled intensity falloff of each viewing zone may be used to predict maximum image intensity for these positions. The maximum image intensity values may be normalized to range between (0-1) for simplicity of explanation. Assuming a maximum image intensity, M, can be produced by any combination of two neighboring viewing zones, weights can be used to attenuate or modulate the respective projector amplitudes for each pixel so that all continuous viewing regions give the same maximum response. Note that a single image is applied to both viewing zones that contribute to the left and right eye position for the viewer. Blending such identical images together with associated weights allows the intensity of the image viewed to be invariant to translations of the eye position.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

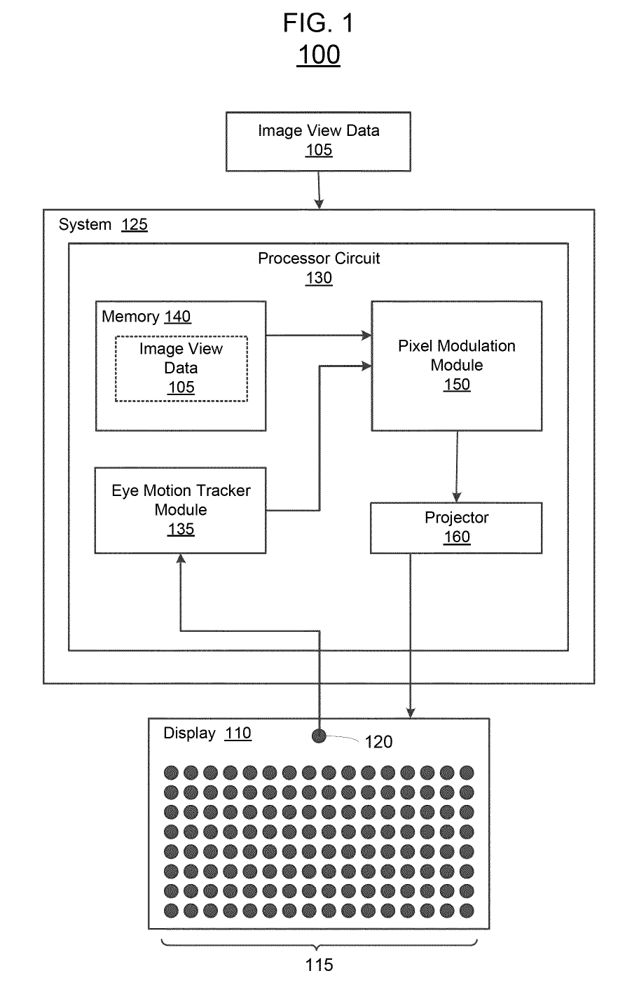

FIG. 1 illustrates one embodiment 100 of a multi-view image adjustment system 125. A display 110 may be a multiview display able to produce multiple ‘zonal views’, each spanning a certain (typically horizontally) region of viewing space. The display 110 is shown with a matrix of pixels 115. The matrix of pixels 115 combine to form an image on the screen of the display. The arrangement of the matrix of pixels 115 as shown is merely exemplary. A computer vision tracker device 120 may also be integrated into front of display 110. The computer vision tracker device 120 may be capable of tracking the location of one or more viewers. Specifically, the computer vision tracker device 120 may track the left and right eye positions of the viewers.

The display 110 may include an embedded system 125 that processes the data acquired by the computer vision tracker device 120 and controls a projector 160 that projects the multiple views on the display 110. The computer vision tracker device 120 forwards its tracking data to an eye motion tracker module 135 under control of a processor circuit 130 within system 125. The computer vision tracker device 120 is in a fixed position with respect to each of the pixels in the matrix of pixels 115. Thus, the eye motion tracker module 135 can translate the tracking data to determine a viewer's left and right eye location with respect to each pixel in the matrix of pixels 115.

The system 125 further includes a memory 140 to store image view data 105 for each of the multiview images to be displayed by display 110. The memory 140 may take several forms including a hard drive, random access memory (RAM), computer flash memory, etc. The embodiments are not limited to these examples. The image view data 105 may be received from an external source (not pictured). The image view data 105 and the tracker data for each pixel generated by the eye motion tracking module 135 may be forwarded to a pixel modulation module 150.

The pixel modulation module 150 may determine the expected and modeled intensity falloff of each viewing zone associated with the multiview images for a given left and right eye location. A viewing zone may be associated on a one-to-one correspondence with each image. Thus, if there are “x” images for a multiview display, there will be “x” viewing zones. Throughout this description when reference is made to a viewing zone it is implied to include its associated image. Similarly, when reference is made to an image it is implied to include its associated viewing zone.

The pixel modulation module 150 may then use the expected and modeled intensity falloff data of each viewing zone to predict a maximum image intensity for the known left and right eye positions. The maximum image intensity values may be normalized to range between 0 and 1 for simplicity of explanation. Assuming a maximum image intensity, M, can be produced by any combination of two neighboring viewing zones (e.g., images), weights can be calculated and used to attenuate or modulate the respective projector 160 amplitudes for each pixel of the matrix of pixels 115 so that all continuous viewing regions give the same maximum response. Note that a single image is applied to both viewing zones that contribute to the left and right eye position for the viewer. Blending such identical images together with associated weights allows the intensity of the image viewed to be invariant to translations of the viewer's eye position.

The adjustments made to the matrix of pixels for the multiview image data by the pixel modulation module 150 may then be forwarded to the projector 160. The projector 160 may then project the modulated image intensity matrix of pixels 115 for each of the viewing zones corresponding to the multiview image data.

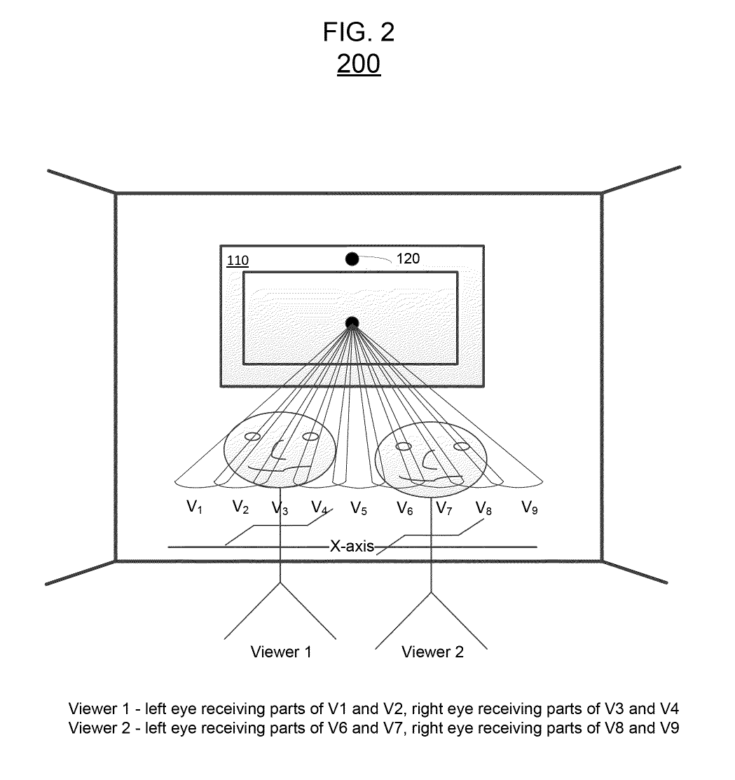

FIG. 2 illustrates an example 200 of a display accommodating two viewers according to an embodiment. Viewers 1 and 2 are standing in front of the display 110. A computer vision tracker device 120 is positioned on the display 110 outside the display's viewing area. The computer vision tracker device 120 tracks the left and right positions of both viewer 1 and viewer 2 and forwards this data to the eye motion tracker module 135. For ease of illustration, a single pixel is illustrated in the display area of display 110. Multiple views (e.g., images) are shown as emanating from the pixel. In this case, there are nine (9) viewing zones meaning that display 110 is a nine-view multiview display.

The left eye of viewer 1 is in the viewing zones for both V1 and V2. The right eye of viewer 1 is in the viewing zones for both V3 and V4. Similarly, the left eye of viewer 2 is in the viewing zones for both V6 and V7 and the right eye of viewer 2 is in the viewing zones for both V8 and V9. With this position data known, the pixel modulation module 150 can calculate the relevant weighting factors for V1 and V2 with respect to the left eye of viewer 1. Similarly, the pixel modulation module 150 can calculate the relevant weighting factors for V3 and V4 with respect to the right eye of viewer 1. At the same time, the pixel modulation module 150 can calculate the relevant weighting factors for V6 and V7 with respect to the left eye of viewer 2. The pixel modulation module 150 can calculate the relevant weighting factors for V8 and V9 with respect to the right eye of viewer 2.

The pixel modulation module 150 may then blend the single image that is applied to both viewing zones that contribute to the left and right eye position for the viewer. Blending such identical images together with the associated weights allows the intensity of the image viewed to be invariant to translations of the eye position. Thus, in this example, the image intensity for V1 and V2 is modulated to accommodate the left eye of viewer 1. The image intensity for V3 and V4 is modulated to accommodate the right eye of viewer 1. The image intensity for V6 and V7 is modulated to accommodate the left eye of viewer 2. The image intensity for V8 and V9 is modulated to accommodate the right eye of viewer 2. To achieve the 3D effect the images associated with V1 and V2 are the same while the images associated with V3 and V4 are the same. However, V1 and V2 are different from V3 and V4. Thus, each eye is receiving a slightly different blended image to create the 3D effect. The same holds true for V6-V9 and viewer 2.

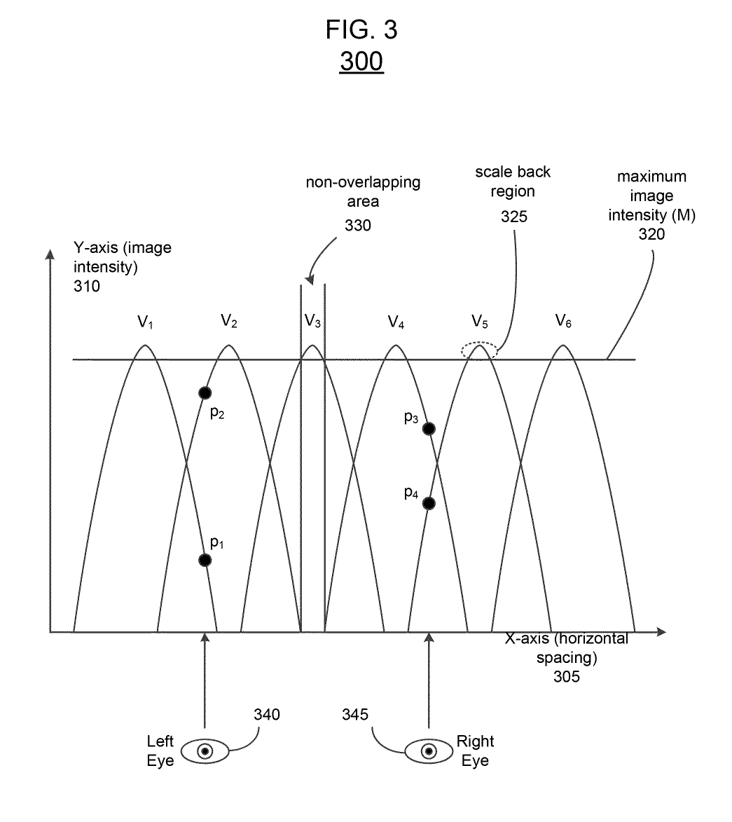

FIG. 3 illustrates an image intensity graph 300 plotted against a horizontal position axis 305 according to an embodiment. Six viewing zones for each of six projected images (V1-V6) are arranged horizontally. The X-axis 305 corresponds to horizontal viewing angle for a viewer and the Y-axis 310 indicates the intensity of each of the six projected images as a function of viewing direction. Each viewing zone an image is seen in is designed to overlap to some extent with neighboring viewing zones to avoid dropouts between views. This leads to crosstalk or bleed through between consecutive views for most viewing directions.

Prior efforts at minimizing bleed through artifacts addressed controlling the spacing of the viewing zones (e.g., V1-V6). The spacing refers to the degree of overlap between consecutive viewing zones of images. Widening the spacing can lessen bleed through but is ineffective at eliminating the bleed through artifacts and actually creates other unwanted artifacts. A fixed intensity profile is assumed for each viewing zone. If the viewing zones for each generated image are spaced wider apart, the bleed through artifact is reduced because there is less overlap between consecutive images. The trade-off, however, is the introduction of dark regions between consecutive viewing zones. On the other hand, if the viewing zones are arranged to overlap more, the dark regions between viewing zones may be reduced but bleed through will be increased. In either case, undesirable artifacts will still be observed.

Two viewpoints, one for the left eye 340 and one for the right eye 345, correspond to the eyes of a viewer at an arbitrary horizontal offset relative to the given viewing zones. Based on the spacing between consecutive viewing zones of images (V1-V6), the amount of overlap which affects both the bleed through artifacts and the dark regions is visible. Each viewing zone includes a non-overlapping area 330 in which there is no overlap with a neighboring viewing zone. The vertical lines that define non-overlapping area 330 intersect the x-axis 305 where a viewing zone's left and right adjacent viewing zones also intersect the x-axis 305. These vertical lines also intersect the viewing zone near but not at its peak. The horizontal line represents the maximum image intensity 320 which should be constant for all images and viewing zones along the x-axis 305. This has been illustrated for V3 but is the same for the other viewing zones. There is also an area referred to as the scale back region 325 in which the y-axis 310 image intensity levels are greater than the maximum image intensity level 320. In these regions, the image intensity may be clipped so as not to exceed the maximum image intensity level 320. This has been illustrated for V5 but is the same for the other viewing zones.

P₁ corresponds to the contribution of the image in viewing zone 1 to the viewer's left eye while P₂ corresponds to the contribution of the image in viewing zone 2 to the viewer's left eye. Similarly, P₃ corresponds to the contribution of the image in viewing zone 4 to the viewer's right eye while P₄ corresponds to the contribution of the image in viewing zone 5 to the viewer's right eye.

Once a viewer's left and right eye position are known, the expected and modeled intensity falloff of each viewing zone may be used to predict maximum image intensity for these positions (e.g., P₁-P₄). The maximum image intensity values may be normalized to range between (0-1) for simplicity of explanation. It is assumed that a maximum image intensity, M, can be produced by any combination of two neighboring viewing zones such as, for instance, V1 and V2 for the left eye position 340 in FIG. 3. Weights W₁ and W₂ can be used to attenuate or modulate the respective projector amplitudes for each pixel so that all continuous viewing regions give the same maximum response of M. The weighting values for W₁ and W₂ can be given as:

$${W}_{1} = \frac{M}{{P}_{1} + {P}_{2}} {P}_{1}$$

$${W}_{2} = \frac{M}{{P}_{1} + {P}_{2}} {P}_{2}$$

The combination of the two contributions from P₁ and P₂ then yield an image of intensity M for image I as:

$${W}_{1} I + {W}_{2} I = \frac{M}{{P}_{1} + {P}_{2}} {P}_{1} I + \frac{M}{{P}_{1} + {P}_{2}} {P}_{2} I = MI$$

Note that a single image is applied to both viewing zones that contribute to the left and right eye position for the viewer. Blending such identical images together with associated weights allows the intensity of the image viewed to be invariant to translations of the eye position. It is assumed that V1 and V2 are derived from the same images, weighted by scaling factors that produce constant image intensity as horizontal offset varies. The same equality holds for the right eye position 345 and V4 and V5 in this example.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation

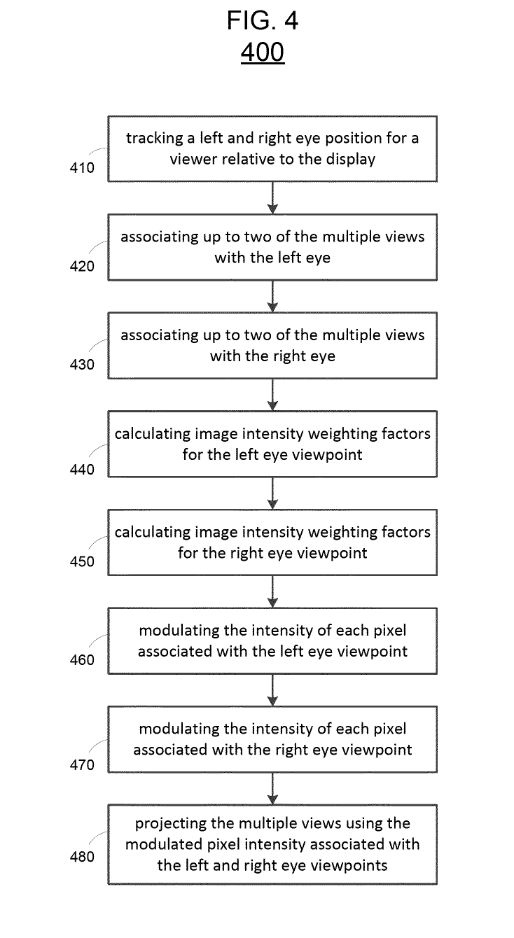

FIG. 4 illustrates an embodiment of a logic flow 400 in which an image intensity may be modulated for the specific viewpoint of a viewer. The logic flow 400 may blend the image data for two viewing zones to create a constant image intensity for each eye of a viewer. The constant image intensity of the blended image minimizes both image bleed through and dark regions between adjacent viewing zones. The logic flow 400 may be representative of some or all of the operations executed by one or more embodiments described herein.

In the illustrated embodiment shown in FIG. 4, a computer vision tracker device 120 may track the eye position for a viewer at block 410. For instance, the computer vision tracker device 120 may track the left and right eye position for a viewer relative to the display 110 to determine a viewpoint for the left and right eye with respect to the matrix of pixels 115 on the display 110. Once known, the left an right eye position of the viewer may be used to customize the viewing experience for a multiview display 110. The embodiments are not limited to this example.

The pixel modulation module 150 may associate two of the views of the multiview display with the left eye of the viewer at block 420. For instance, the multiview display may be able to present nine (9) views across a horizontal viewing area as shown in FIG. 2. Each viewing zone may be associated with one of the nine images. The viewing zones are intended to overlap to a certain extent to avoid unwanted dark region artifacts. Because adjacent views overlap, it is common for the eye of a viewer to be within two viewing zones at the same time. This leads to bleed through of the corresponding images. The embodiments are not limited to this example.

The pixel modulation module 150 may associate two of the views of the multiview display with the right eye of the viewer at block 430. Just as for the left eye, the right eye may be within two viewing zones at the same time. This leads to bleed through of the corresponding images. The embodiments are not limited to this example.

The pixel modulation module 150 may calculate image intensity weighting factors for the image data corresponding to the viewing zones inhabited by the left eye of the viewer at block 440. Using FIG. 3 as an example, the left eye 340 of the viewer may inhabit viewing zones V1 and V2. The image intensity values for the image data for each of the viewing zones is plotted against a horizontal spacing x-axis 305. Where the eye falls on the x-axis 305 will determine the intensity of the contribution from each viewing zone—in this case V1 and V2. The points P₁ and P₂ represent the image intensity values for the left eye 340 for V1 and V2 respectively. P₁ and P₂ may be weighted by a factor such that when added together they equal a unity value that represents the maximum image intensity for a blended image. For example, P₁ may represent 20% of the image intensity while P₂ represents 80%. If this were the case, the weighting factor for P₁ would be 0.2 and the weighting factor for P₂ would be 0.8. The sum of the weighting factors of P₁ and P₂ would equal 1.0 meaning the blended contribution from both viewing zones would not exceed or fall below the maximum intensity level 320. As described above the weighting factors may be calculated according to

$${W}_{1} = \frac{M}{{P}_{1} + {P}_{2}} {P}_{1} and {W}_{2} = \frac{M}{{P}_{1} + {P}_{2}} {P}_{2}$$

The embodiments are not limited to this example.

The pixel modulation module 150 may calculate image intensity weighting factors for the image data corresponding to the viewing zones inhabited by the right eye of the viewer at block 450. Using FIG. 3 again as an example, the right eye 345 of the viewer may inhabit viewing zones V4 and V5. The image intensity values for the image data for each of the viewing zones is plotted against a horizontal spacing x-axis 305. Where the eye falls on the x-axis 305 will determine the intensity of the contribution from each viewing zone—in this case V4 and V5. The points P₃ and P₄ represent the image intensity values for the right eye 345 for V4 and V5 respectively. P₃ and P₄ may be weighted by a factor such that when added together they equal a unity value that represents the maximum image intensity for a blended image. For example, P₃ may represent 60% of the image intensity while P₄ represents 40%. If this were the case, the weighting factor for P₃ would be 0.6 and the weighting factor for P₄ would be 0.4. The sum of the weighting factors of P₃ and P₄ would equal 1.0 meaning the blended contribution from both viewing zones would not exceed or fall below the maximum intensity level 320. As described above the weighting factors may be calculated according to

$${W}_{3} = \frac{M}{{P}_{3} + {P}_{4}} {P}_{3} and {W}_{4} = \frac{M}{{P}_{3} + {P}_{4}} {P}_{4}$$

The embodiments are not limited to this example.

The pixel modulation module 150 may modulate the image intensity of the pixels for the left eye 340 at block 460. For example, the image intensity weighting values W₁ and W₂ that correspond to the image data for identical images in viewing zones V1 and V2 may be used to blend the images together which results in an image intensity that is invariant to translations (e.g., horizontal movements) of the eye. Blending the two images into one eliminates the bleed through artifact since the viewer's eye is presented with a single image intensity value rather than two different image intensity values. In addition, dark region artifacts are avoided because the two images combine to present the maximum image intensity 320 for, in this case, the viewpoint of the left eye 340. The embodiments are not limited to this example.

The pixel modulation module 150 may modulate the image intensity of the pixels for the right eye 345 at block 470. For example, the image intensity weighting values W₃ and W₄ that correspond to the image data for identical images in viewing zones V4 and V5 may be used to blend the images together which results in an image intensity that is invariant to translations (e.g., horizontal movements) of the eye. Blending the two images into one eliminates the bleed through artifact since the viewer's eye is presented with a single image intensity value rather than two different image intensity values. In addition, dark region artifacts are avoided because the two images combine to present the maximum image intensity 320 for, in this case, the viewpoint of the right eye 345. The embodiments are not limited to this example.

The projector may project the multiview images to the display 110 via the matrix of pixels 115 at block 480. For example, the projector 160 may receive the modulated intensity values for each pixel of each image. The pixel intensities have been modulated to present the optimal image intensity based on the exact location of the viewer so as to minimize or eliminate bleed through artifacts of adjacent images and dark region artifacts. The embodiments are not limited to this example.

Using the principles of the described embodiments above, two additional applications of the view weighting system can be explained. The first may be referred to as view selection and the second may be referred to as view synthesis.

### View Selection

For each viewer that is being tracked, specific left and right eye images can be sent with exactly the same images being prepared for all viewers (albeit different for each eye to achieve a 3D effect). There are several advantages to such a view selection approach. For example, the director of the visual experience being presented has control over the viewpoint being shown, which can be advantageous from a storytelling/scripting perspective. Thus, each viewer sees the video from the exact same perspective. In addition, only two slightly offset views need to be filmed or generated to provide a stereo 3D viewing experience to several viewers. This reduces system bandwidth requirements as well as filming complexity.

### View Synthesis

Since the position of each viewer's eyes are tracked in real time, views specific to their location can be generated. In this example, two viewers may perceive an image differently depending on their actual viewpoint with respect to the display. For imagery computed with computer graphics, this is quite straightforward and involves rendering the frames of 3D models from the determined viewer perspectives. For live video, view synthesis techniques can be used to generate views from arbitrary locations from camera streams with known location. These view synthesis techniques typically build a 3D representation of the scene using stereo correspondence techniques, then warp or re-render these to a desired perspective.

In both the computer generated and live video case, the techniques described herein enable a truly continuous, 3D display since movement of the viewer's eyes, even at translations smaller than the projector spacing, yield new, desired views. The techniques also put a bound on the number of projectors required to achieve continuous display given a maximum distance to the viewer. This can be determined since a minimum of two projector spacings are required between a viewer's left and right eyes for the weighting techniques described herein.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A method of presenting multiple horizontally offset views, each view comprised of image data, the method comprising:
tracking a left and right eye position for a viewer relative to the display to determine a viewpoint for the left and right eye;
associating two of the multiple views with the left eye position and two of the multiple views with the right eye position;
calculating image intensity weighting factors for the two left eye views and image intensity weighting factors for the two right eye views;
modulating the intensity of each view associated with the left eye position according to the weighting factors determined for the left eye position and the intensity of each view associated with the right eye position according to the weighting factors determined for the right eye position; and
blending the two left eye views into a single view to be perceived by the left eye and the two right eye views into a single view to be perceived by the right eye.

2. The method of claim 1, each horizontally offset view comprising image data represented as a matrix of pixels.

3. The method of claim 2, the associating, calculating, modulating, and blending steps performed on each pixel of each view associated with the left and right eye position.

4. The method of claim 3, projecting only the blended single views associated with the left and right eye positions.

5. The method of claim 1, the two views associated with the left eye position being identical images, the two views associated with the right eye position being identical images that are different from the two views associated with the left eye.

6. The method of claim 1, the tracking performed in real-time.

7. The method of claim 1, the multiple views being computer generated.

8. The method of claim 1, the multiple views being live video.

9. A system comprising:
a multiview display to display multiple horizontally offset views, each view comprised of image data; and
a processor circuit to control a computer vision tracker device, an eye motion tracker module, and a pixel modulation module,
the computer vision tracker device coupled with the eye motion tracker module to track and determine the left eye position and right eye position of a viewer;
the pixel modulation module to: (i) associate two of the multiple views with the left eye position and two of the multiple views with the right eye position; (ii) calculate image intensity weighting factors for the two left eye views and image intensity weighting factors for the two right eye views; (iii) modulate the intensity of each view associated with the left eye position according to the weighting factors determined for the left eye position and the intensity of each view associated with the right eye position according to the weighting factors determined for the right eye position; and (iv) blend the two left eye views into a single view to be perceived by the left eye and the two right eye views into a single view to be perceived by the right eye; and
a projector to project the blended single views for the left eye position and the right eye position.

10. The system of claim 9, each horizontally offset view comprising image data represented as a matrix of pixels.

11. The system of claim 10, the pixel modulation module operating on each pixel of each view associated with the left and right eye position.

12. The system of claim 9, the multiple views being computer generated.

13. The system of claim 9, the multiple views being live video.

14. An article of manufacture comprising a non-transitory computer-readable storage medium containing instructions that if executed enable a system to:
track an eye position for a viewer relative to the display to determine a viewpoint for the eye;
associate two of the multiple views with the eye position;
calculate image intensity weighting factors for the two eye views;
modulate the intensity of each view associated with the eye position according to the weighting factors determined for the eye position; and
blend the two eye views into a single view to be perceived by the eye.

15. The article of claim 14, further comprising instructions that if executed enable the system to project only the blended single view associated with the eye position.
